(19) United States
(12) Patent Application Publication
(10) Pub. No.: US 2024/0259168 A1
(43) Pub. Date: Aug. 1, 2024

(54) ACCESS POINT, STATION, AND WIRELESS COMMUNICATION METHOD

(71) Applicant: GUANGDONG OPPO MOBILE TELECOMMUNICATIONS CORP., LTD., Dongguan (CN)

(72) Inventor: Lei HUANG, Singapore (SG)

(21) Appl. No.: 18/632,857

(22) Filed: Apr. 11, 2024

Related U.S. Application Data
(63) Continuation of application No. PCT/CN2022/112872, filed on Aug. 16, 2022.

(30) Foreign Application Priority Data
Oct. 15, 2021 (SG) 10202111492Q

(51) Int. Cl. H04L 5/00; H04L 1/00

(52) U.S. Cl. CPC H04L 5/0092; H04L 1/0013; H04L 5/0048

(57) ABSTRACT

An access point (AP), a station (STA), and a wireless communication method are provided. The wireless communication method by the AP includes transmitting, to one or more stations (STAs) by the AP involved in a multi-AP coordinated uplink (UL) transmission, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS.

### CROSS-REFERENCE TO RELATED APPLICATION(S)

This application is a continuation of International Application No. PCT/CN2022/112872, filed Aug. 16, 2022, which claims priority to Singapore Patent Application No. 10202111492Q, filed Oct. 15, 2021, the entire disclosures of which are hereby incorporated by reference.

### TECHNICAL FIELD

The present disclosure relates to the field of communication systems, and more particularly, to an access point (AP), a station (STA), and a wireless communication method.

### BACKGROUND

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as, time, frequency, and power). A wireless network, for example a wireless local area network (WLAN), such as a Wi-Fi (institute of electrical and electronics engineers (IEEE) 802.11) network may include an access point (AP) that may communicate with one or more stations (STAs) or mobile devices. The WLAN enables a user to wirelessly access an internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink may refer to a communication link from the AP to the STA, and the uplink may refer to a communication link from the STA to the AP.

IEEE 802.11 TGbe is developing anew IEEE 802.11 amendment which defines extremely high throughput (EHT) physical layer (PHY) and medium access control (MAC) layers capable of supporting a maximum throughput of at least 30 Gbps. To this end, it has been proposed to increase maximum channel bandwidth to 320 MHz and increase maximum number of spatial streams to 16. In addition, it has been proposed to enable multi-AP coordination in a multi-AP system in order to improve system throughput. Example multi-AP coordination schemes include multi-AP coordinated uplink (UL) orthogonal frequency division multiple access (OFDMA) and multi-AP coordinated UL multi-user multiple input multiple output (MU-MIMO), etc. However, it is still an open issue to efficiently implement multi-AP UL coordination in a multi-AP system.

Therefore, there is a need for an access point (AP), a station (STA), and a wireless communication method, which can solve issues in the prior art, efficiently implement multi-AP uplink (UL) coordination in a multi-AP system, achieve extremely high throughput, provide good communication performance, and/or provide high reliability.

### SUMMARY

In a first aspect of the present disclosure, a wireless communication method by a station (STA) comprises receiving, from an access point (AP) involved in a multi-AP coordinated uplink (UL) transmission, a trigger frame, where the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS.

In a second aspect of the present disclosure, a station (STA) comprises a memory configured to store instructions, a transceiver, and a processor coupled to the memory and the transceiver. The instructions, when executed, cause the STA to perform the above method.

In a third aspect of the present disclosure, an AP comprises a memory configured to store instructions, a transceiver, and a processor coupled to the memory and the transceiver. The instructions, when executed, cause the AP involved in a multi-AP coordinated UL transmission to transmit, to one or more STAs, a trigger frame, where the trigger frame comprises a BSS/VBSS subfield, and the BSS/VBSS subfield indicates whether solicited EHT TB PPDUs are transmitted in a BSS or a VBSS.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example AP candidate set which comprises APs according to an embodiment of the present disclosure.

FIG. 2 is a schematic diagram illustrating an example multi-AP coordinated UL transmission according to an embodiment of the present disclosure.

FIG. 3A is a schematic diagram illustrating a bandwidth allocation for multiple EHT TB PPDU sets according to an embodiment of the present disclosure.

FIG. 3B is a schematic diagram illustrating a bandwidth allocation for multiple EHT TB PPDU sets according to an embodiment of the present disclosure.

FIG. 3C is a schematic diagram illustrating a bandwidth allocation for multiple EHT TB PPDU sets according to an embodiment of the present disclosure.

FIG. 3D is a schematic diagram illustrating a bandwidth allocation for multiple EHT TB PPDU sets according to an embodiment of the present disclosure.

FIG. 3E is a schematic diagram illustrating a bandwidth allocation for multiple EHT TB PPDU sets according to an embodiment of the present disclosure.

FIG. 4 is a schematic diagram illustrating a trigger frame format according to an embodiment of the present disclosure.

FIG. 5A is a schematic diagram illustrating an EHT variant common information field format according to an embodiment of the present disclosure.

FIG. 5B is a schematic diagram illustrating a special user information field format according to an embodiment of the present disclosure.

FIG. 5C is a schematic diagram illustrating an EHT variant common information field format according to an embodiment of the present disclosure.

FIG. 5D is a schematic diagram illustrating a special user information field format according to an embodiment of the present disclosure.

FIG. 5E is a schematic diagram illustrating an EHT variant user information field format according to an embodiment of the present disclosure.

FIG. 6 is a schematic diagram illustrating an EHT TB PPDU format according to an embodiment of the present disclosure.

FIG. 7 is a schematic diagram illustrating an example of a wireless communications system according to an embodiment of the present disclosure.

FIG. 8 is a schematic diagram illustrating an example of a wireless communications system according to another embodiment of the present disclosure.

FIG. 9 is a schematic diagram illustrating an example of a wireless communications system according to another embodiment of the present disclosure.

FIG. 10 is a block diagram of one or more stations (STAs) and an access point (AP) of communication in a wireless communications system according to an embodiment of the present disclosure.

FIG. 11 is a flowchart illustrating a wireless communication method performed by an AP according to an embodiment of the present disclosure.

FIG. 12 is a flowchart illustrating a wireless communication method performed by an AP according to an embodiment of the present disclosure.

FIG. 13 is a flowchart illustrating a wireless communication method performed by a STA according to another embodiment of the present disclosure.

FIG. 14 is a flowchart illustrating a wireless communication method performed by a STA according to another embodiment of the present disclosure.

FIG. 15 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

TABLE 1

| Abbreviation | Full name |
|---|---|
| IEEE | Institute of Electrical and Electronics Engineers |
| WLAN | Wireless local area network |
| BSS | Basic service set |
| VBSS | Virtual BSS |
| AP | Access point |
| STA | Station |
| PHY | Physical layer |
| MAC | Medium access control |
| MPDU | MAC protocol data unit |
| PPDU | Physical layer protocol data unit |
| A-PPDU | aggregated PPDU |
| HT | High throughput |
| HE | High efficiency |
| EHT | Extremely high throughput |
| MU | Multi-user |
| OFDMA | Orthogonal frequency division multiple access |
| L-LTF | Non-HT Long Training field |
| L-STF | Non-HT Short Training field |
| L-SIG | Non-HT SIGNAL field |
| RL-SIG | Repeated L-SIG |
| U-SIG | Universal SIGNAL field |
| EHT-STF | EHT Short Training field |
| EHT-LTF | EHT Long Training field |
| PE | Packet Extension field |
| BW | Bandwidth |
| GI | Guard interval |
| RU | Resource unit |
| MRU | Multiple resource unit |
| TXOP | Transmission opportunity |
| MIMO | Multiple input multiple output |
| MIB | Management information base |
| MAPC | Multi-AP coordination |
| MLD | Multi-link device |
| SME | Station management entity |
| AID | Association identifier |
| VAID | Virtual AID |
| VBSSID | VBSS identifier |
| SSID | Service set identifier |
| BSSID | BSS identifier |

AP refers to a standalone AP or an AP affiliated with an AP MLD; and STA refers to a standalone non-AP STA or an STA affiliated with a non-AP MLD. dot11EHTBaseLineFeaturesImplementedOnly and dot11Multi-APCoordinationOptionImplemented are two of MIB variables maintained by an STA's (or an AP's) SME. STA (or AP) with dot11EHTBlaseLineFeaturesImplementedOnly equal to true refers to an EHT STA (or an EHT AP) that supports one or more EHT baseline features such as MRU and multi-link operation which have been defined in IEEE 802.11be D1.2; but does not support any EHT advanced features such as multi-AP coordination which will be defined in a later draft of IEEE 802.11be (e.g. IEEE 802.11be D3.0), i.e. WiFi7 R1 STA (or AP). STA (or AP) with dot11EHTBaseLineFeaturesImplementedOnly equal to false refers to an EHT STA (or an EHT AP) that support one or more EHT baseline features which have been defined in IEEE 802.11be D1.2 and one or more EHT advanced features which will be defined in a later draft of IEEE 802.11be (e.g., IEEE 802.11be D3.0), i.e., WiFi7 R2 STA (or AP). STA (or AP) with dot11Multi-APCoordinationOptionImplemented equal to true refers to an EHT STA (or an EHT AP) that supports multi-AP coordination; and STA (or AP) with dot11Multi-APCoordinationOptionImplemented equal to false refers to an EHT STA (or an EHT AP) that does not support multi-AP coordination. STA (or AP) with dot11EHTBaseLineFeaturesImplementedOnly equal to false and dot11Multi-APCoordinationOptionImplemented equal to true is called a multi-AP coordination (MAPC) capable STA (or AP); and STA (or AP) with dot11EHTBaseLineFeaturesImplementedOnly equal to true or with both dot11EHTBaseLineFeaturesImplementedOnly and dot11Multi-APCoordinationOptionImplemented equal to false is called a MAPC incapable STA (or AP) thereafter.

An AP candidate set is a set of MAPC capable APs that can initiate or participate in a multi-AP coordination. A coordinator which is responsible for establishing and maintaining an AP candidate set may be a member AP of the AP candidate set or outside of the AP candidate set. An AP which obtains a TXOP and initiates a multi-AP coordination is the sharing AP. An AP in an AP candidate set can participate as a shared AP in a multi-AP coordination initiated by a sharing AP in the same AP candidate set. At least one AP in an AP candidate set shall be capable of being a sharing AP. A multi-AP coordination may include a multi-AP coordination preparation phase and a multi-AP coordinated transmission phase. In the multi-AP coordination preparation phase, a sharing AP obtaining a TXOP and initiating the multi-AP coordination may transmit a first frame to one or more AP in the same AP candidate set to inquire about respective intentions to participate in the multi-AP coordination. Each of the one or more AP will respond with a second frame to inform the sharing AP of whether it intends to participate in the multi-AP coordination. For example, the first frame may include information indicating an intended multi-AP coordination scheme, and any AP that receives the first frame may get that the sharing AP is inquiring about its intention to participate in the multi-AP coordination, based on the intended multi-AP coordination scheme. If an AP intends to participate in the multi-AP coordination, it becomes a shared AP in the multi-AP coordination. In the multi-AP coordinated transmission phase, the sharing AP and one or more shared AP may participate in a multi-AP coordinated transmission. Alternatively, the sharing AP may not participate in a multi-AP coordinated transmission; and two or more shared APs may participate in a multi-AP coordinated transmission.

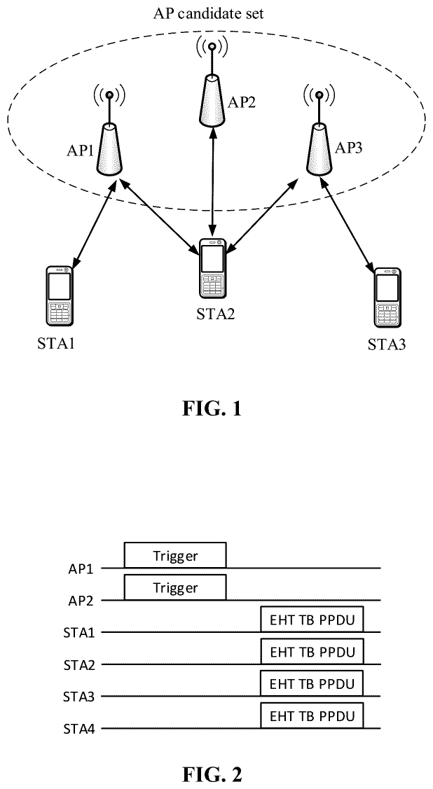

FIG. 1 illustrates an example AP candidate set which comprises three APs: AP1, AP2 and AP3. In an instant, AP1 may obtain a TXOP and initiate a multi-AP coordination as the sharing AP while AP2 and AP3 may participate as the shared APs in the multi-AP coordination. AP1, AP2 and AP3 may participate in a multi-AP coordinated transmission (e.g., multi-AP coordinated UL OFDMA transmission or multi-AP coordinated UL MU-MIMO transmission) in the TXOP. In another instant, AP2 may obtain a TXOP and initiate a multi-AP coordination as the sharing AP; and AP1 and AP3 may participate as the shared APs in the multi-AP coordination. AP1 and AP3 may participate in a multi-AP coordinated transmission in the TXOP but AP2 does not participate in the multi-AP coordinated transmission.

According to some embodiments of the present disclosure, an AP candidate set forms a virtual BSS (VBSS), which may be identified by a MAC address (i.e., VBSSID). An AP candidate set or a VBSS can also be identified by a VBSS color. In one embodiment, VBSS colors are in a same value space with BSS colors. In this case, the value range of a VBSS color does not overlap with the value range of a BSS color. For example, the value of a BSS color ranges from 0 to N; and the value of a VBSS color ranges from N+1 to 63; where N is a positive integer ranging from 1 to 62 and the value of N is pre-defined or configurable. The value of N may be indicated in the Beacon, Probe Response frame, Association Response frame and/or Reassociation Response frame. In another embodiment, VBSS colors are in a different value space with BSS colors. In this case, the value range of a VBSS color may overlap with the value range of a BSS color. An AP may belong to more than one AP candidate set. An AP candidate set may include up to eight APs and each AP in an AP candidate set is identified by an AP ID. An AP may indicate configuration information and operational parameters of each AP candidate set of which it is a member in transmitted Beacon and/or Probe Response frames. The configuration information and operational parameters of an AP candidate set may comprise SSID, Short SSID, VBSSID; VBSS color, BSSID of each member AP excluding the transmitting AP, BSS color of each member AP excluding the transmitting AP; and/or supported multi-AP coordinated transmission schemes. At any given instant, a MAPC capable STA is associated with no more than one AP candidate set. A MAPC capable STA may establish an association with an AP candidate set via a member AP of the AP candidate set wherein the member AP is called anchor AP of the STA. In one embodiment, the STA shall be associated with its anchor AP before it is associated with the AP candidate set via its anchor AP. In another embodiment, the STA may establish an association with its anchor AP and the AP candidate set simultaneously.

In some embodiments, during a MAPC capable STA establishes an association with an AP candidate set via its anchor AP, e.g., using Association Request/Response or Reassociation Request/Response frame exchange, the STA may be informed of configuration information and operational parameters of the associated AP candidate set and assigned with a virtual AID (VAID) which identifies the STA in the AP candidate set's VBSS. In one embodiment, VAIDs may be in a different value space from AIDs. In this case, the value range of a VAID may overlap with the value range of an AID. In another embodiment, VAIDs may be in a same value space as AIDs. In this case, the value range of a VAID does not overlap with the value range of an AID. For example, the value of an AID ranges from 1 to M; and the value of a VAID ranges from M+1 to 2007, where M is a positive integer ranging from 2 to 2006 and the value of M is pre-defined or configurable. The value of M may be indicated in the Beacon, Probe Response frame, Association Response frame and/or Reassociation Response frame. After a MAPC capable STA is associated with an AP candidate set via its anchor AP, in the AP candidate set's VBSS, the STA may transmit a single PSDU to or receive one or more PSDUs from one or more AP in the AP candidate set in a multi-AP coordinated transmission which involves more than one APs. In a multi-AP coordinated transmission, when a STA transmit a single PSDU to or receive more than one PSDU from more than one APs, the more than one APs comprises the STA's anchor AP. In a multi-AP coordinated transmission, when a STA transmit a single PSDU to or receive a single PSDU from a single AP, the AP is the STA's anchor AP. Alternatively, the AP is any AP involved in the multi-AP coordinated transmission. In addition, the STA may transmit a single PSDU to or receive a single PSDU from a single AP in a non-coordinated transmission. The single AP is STA's anchor AP. Alternatively, the single STA is any AP in the AP candidate set. Taking the multi-AP system as illustrated in FIG. 1 as an example where STA2's anchor AP is assumed to AP2. In a multi-AP coordinated transmission, STA2 may transmit a single PSDU to or receive a single PSDU from AP2 only; or transmit a single PSDU to or receive two or more PSDUs from AP2 and at least one of AP1 and AP3. In a non-coordinated transmission, STA2 may transmit a single PSDU to or receive a single PSDU from AP2 only.

A multi-AP coordinated UL transmission is a multi-AP coordinated UL OFDMA transmission or a multi-AP coordinated UL MU-MIMO transmission. In a multi-AP coordinated UL MU-MIMO transmission, two or more of sharing AP and shared AP(s) transmit respective Trigger frames to solicit transmissions of respective EHT TB PPDUs at a single RU or MRU that occupies all non-punctured 20 MHz channels within a coordinated transmission bandwidth. In a multi-AP coordinated UL OFDMA transmission, two or more of sharing AP and shared AP(s) transmit respective Trigger frames to solicit transmissions of respective EHT TB PPDUs within different frequency portions of a coordinated transmission bandwidth where each frequency portion comprises one or more 80 MHz frequency subblock. In a multi-AP coordinated UL OFDMA transmission, more than one of sharing AP and shared AP(s) may transmit respective Trigger frame to solicit transmissions of respective EHT TB PPDUs at a single RU or MRU that occupies all the non-punctured 20 MHz channels within a same frequency portion of a coordinated transmission bandwidth in a similar manner to a multi-AP coordinated UL MU-MIMO transmission. A multi-AP coordinated UL MU-MIMO transmission is applicable to a coordinated transmission bandwidth of 20 MHz, 40 MHz, 80 MHz, 160 MHz or 320 MHz. A multi-AP coordinated UL OFDMA transmission is applicable to a coordinated transmission bandwidth of 160 MHz or 320 MHz but not applicable to a coordinated transmission bandwidth of 20 MHz, 40 MHz or 80 MHz.

In one embodiment, each AP involved in a multi-AP coordinated UL transmission may transmit a Trigger frame to solicit EHT TB PPDU transmissions from one or more STAs of which the AP is the anchor AP. In this case, the TA field of a Trigger frame is set to the BSSID of the transmitting AP. In another embodiment, each AP involved in a multi-AP coordinated UL transmission may transmit a Trigger frame to solicit EHT TB PPDU transmissions from one or more STAs, wherein the AP may not be the anchor AP of at least one of the STAs. For example, each AP involved in a multi-AP coordinated UL transmission may transmit a same Trigger frame to solicit EHT TB PPDU transmissions from one or more STAs. In this case, the TA field of a Trigger frame is set to the VBSSID of the AP candidate set with which the STAs are associated.

FIG. 2 illustrates an example multi-AP coordinated UL transmission wherein AP1 and AP2 belong to an AP candidate set; AP1 is the anchor AP of STA1 and STA2; and AP2 is the anchor AP of STA3 and STA4. AP1 transmits a first Trigger frame to STA1 and STA2 to solicit EHT TB PPDU transmissions from STA1 and STA2, where the TA address of the first Trigger frame is set to the AP1's BSSID. Simultaneously, AP2 transmits a second Trigger frame to STA3 and STA4 to solicit EHT TB PPDU transmissions from STA3 and STA4, where the TA address of the second Trigger frame is set to the AP2's BSSID. Alternatively, AP1 and AP2 simultaneously transmit a same Trigger frame to solicit EHT TB PPDU transmissions from all of STA1, STA2, STA3 and STA4, where the TA address of the Trigger frame is set to the VBSSID of the AP candidate set.

In a multi-AP coordinated UL transmission, when EHT TB PPDUs solicited by a Trigger frame which is carried in an EHT MU PPDU, together with EHT TB PPDUs solicited by any of other Trigger frames, are transmitted at a same RU or MRU that occupies all non-punctured 20 MHz channels within a coordinated transmission bandwidth or a frequency portion of the coordinated transmission bandwidth, a BSS/VBSS subfield of the EHT MU PPDU shall be set to indicate that the EHT MU PPDU is transmitted in a VBSS and/or a BSS/VBSS Color subfield of the EHT MU PPDU shall be set to indicate a VBSS color of the VBSS. When EHT TB PPDUs solicited by a Trigger frame which is carried in an EHT MU PPDU are transmitted in different frequency portions of a coordinated transmission bandwidth from EHT TB PPDUs solicited by any of other Trigger frames and the transmitting AP of the EHT MU PPDU is the anchor AP of all the STAs intended by the Trigger frame, the BSS/VBSS subfield of the EHT MU PPDU may be set to indicate that the EHT MU PPDU is transmitted in a BSS and/or the BSS/VBSS Color subfield of the EHT MU PPDU may be set to indicate the BSS color of the BSS. When EHT TB PPDUs solicited by a Trigger frame which is carried in an EHT MU PPDU are transmitted in different frequency portions of a coordinated transmission bandwidth from EHT TB PPDUs solicited by any of other Trigger frames and the transmitting AP of the EHT MU PPDU is not the anchor AP of at least one of the STAs intended by the Trigger frame, the BSS/VBSS subfield of the EHT MU PPDU shall be set to indicate that the EHT MU PPDU is transmitted in a VBSS and/or the BSS/VBSS Color subfield of the EHT MU PPDU shall be set to indicate a VBSS color of the VBSS.

In a multi-AP coordinated UL transmission, EHT TB PPDUs solicited by two or more of sharing AP and shared AP(s) shall have a same GI and EHT-LTF type, a same number of EHT-LTF symbols and a same duration of Data field and PE field. As a result, all the EHT TB PPDUs have a same transmission time. When two or more of sharing AP and shared AP(s) solicit respective EHT TB PPDUs at a single RU or MRU that occupies all non-punctured 20 MHz channels within a coordinated transmission bandwidth or a same frequency portion of a coordinated transmission bandwidth, the U-SIG fields of the transmitted EHT TB PPDUs shall have the same content. In a multi-AP coordinated UL OFDMA transmission, EHT TB PPDUs transmitted by two or more of sharing AP and shared AP(s) are aggregated in frequency domain and forms a TB A-PPDU. A TB A-PPDU consists of multiple EHT TB PPDU sets, each of which comprises one or more EHT TB PPDUs transmitted within a same frequency portion of the coordinated transmission bandwidth.

For a multi-AP coordinated UL OFDMA transmission with a coordinated transmission bandwidth of 160 MHz, two 80 MHz frequency subblocks are allocated to two EHT TB PPDU sets, respectively. For a multi-AP coordinated UL OFDMA transmission with a coordinated transmission bandwidth of 320 MHz, there may have the following five options for bandwidth allocation for multiple EHT TB PPDU sets:

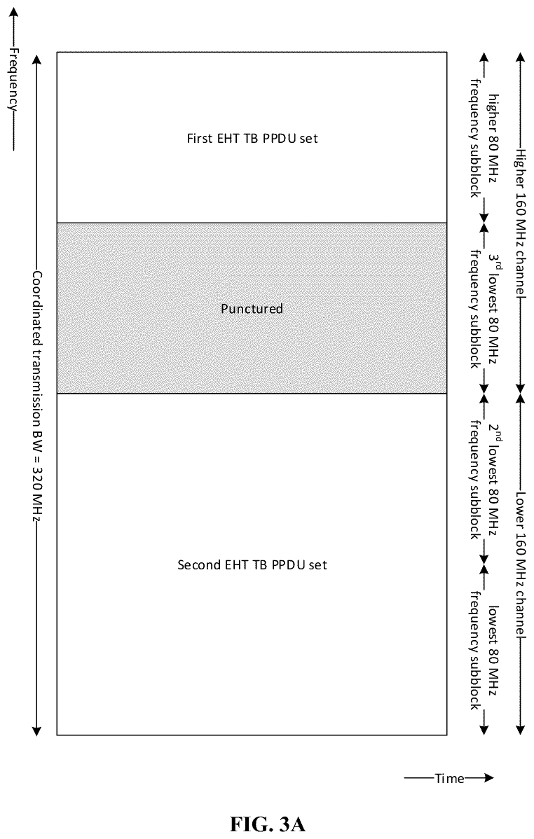

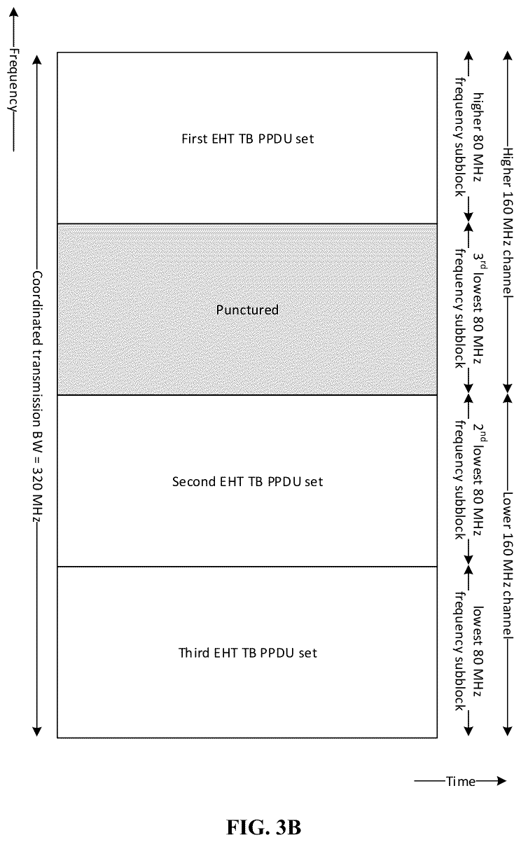

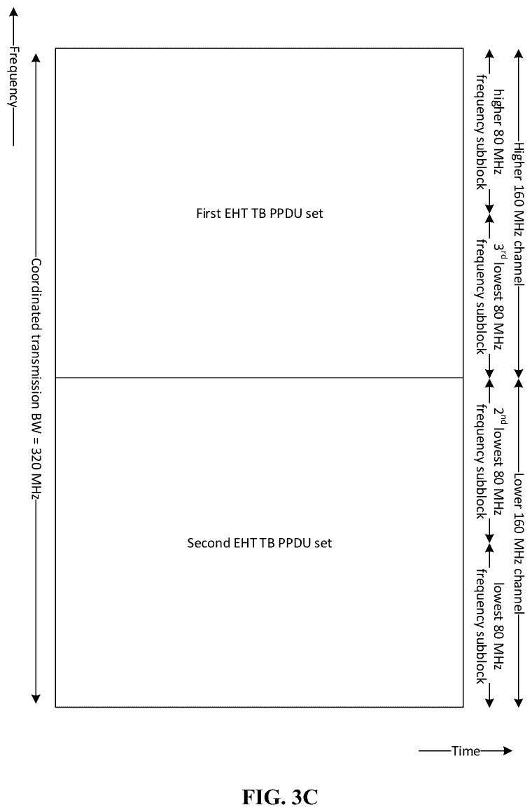

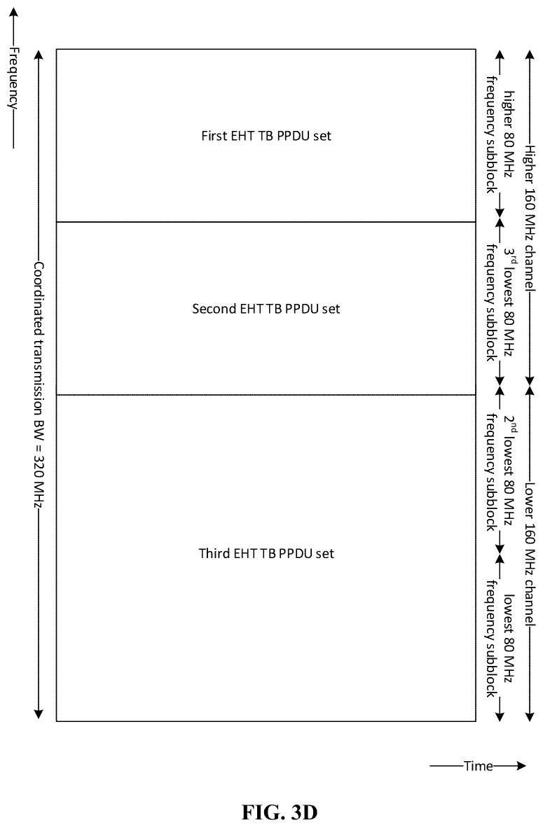

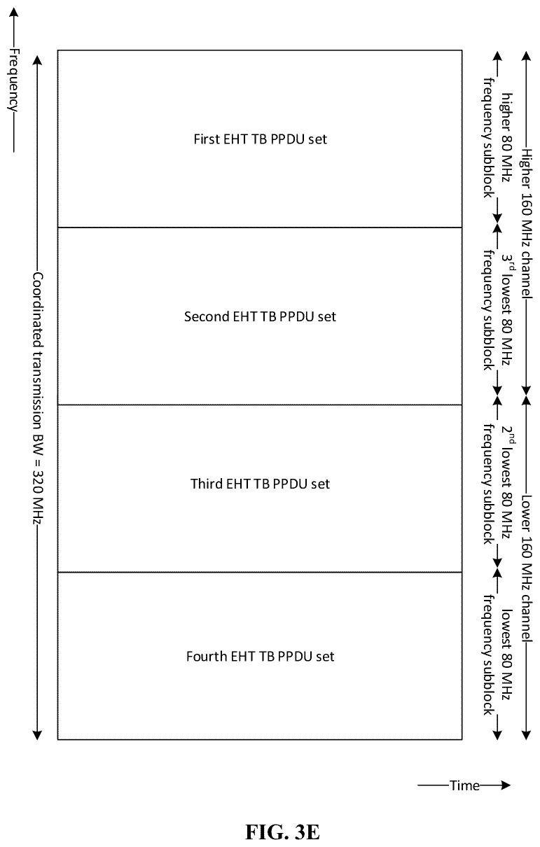

Option 1A: When one of 80 MHz frequency subblocks is punctured, the non-punctured 80 MHz frequency subblock which is within a same 160 MHz channel as the punctured 80 MHz frequency subblock is allocated to a first EHT TB PPDU set, and the other 160 MHz channel is allocated to a second EHT TB PPDU set, as illustrated in FIG. 3A.

Option 1B: When one of 80 MHz frequency subblocks is punctured, three non-punctured 80 MHz frequency subblocks are allocated to three EHT TB PPDU sets, respectively, as illustrated in FIG. 3B.

Option 1C: Two 160 MHz channels are allocated to two EHT TB PPDU sets, respectively, as illustrated in FIG. 3C.

Option 1D: Two 80 MHz frequency subblocks within a same 160 MHz channel are allocated to first two EHT TB PPDU sets, respectively; and the other 160 MHz channel is allocated to a third EHT TB PPDU set, as illustrated in FIG. 3D.

Option 1E: Four 80 MHz frequency subblocks are allocated to four EHT TB PPDU sets, respectively, as illustrated in FIG. 3E.

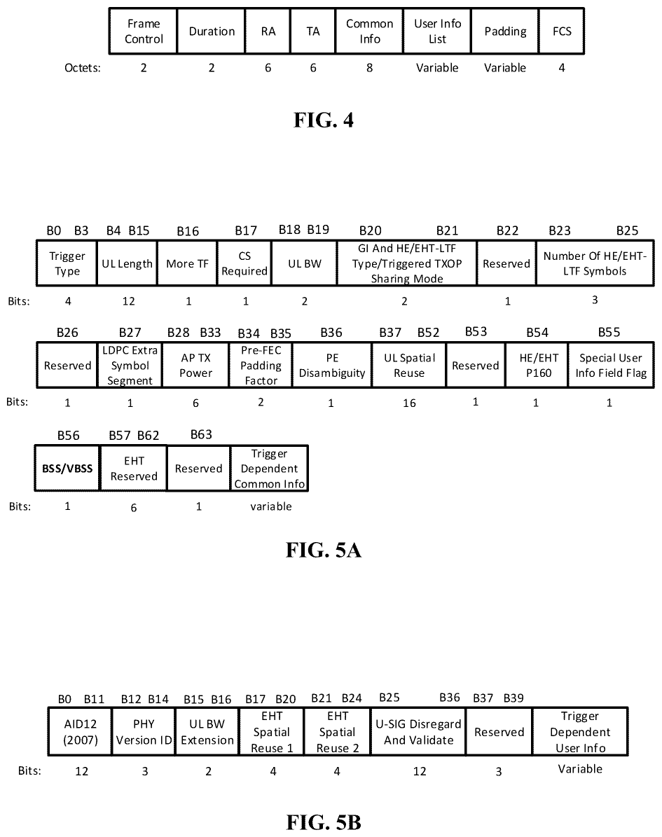

In some embodiments, The Trigger frame format is illustrated in FIG. 4, which includes a Common Info field and a User Info List field comprising one or more User Info fields. The formats of the Common Info field and User Info field depend on the type of Trigger frame. The Common Info field of Trigger frame has two variants: HE variant and EHT variant. An EHT STA interprets the Common Info field as HE variant if B54 and B55 in the Common Info field are equal to 1; and interprets the Common Info field as EHT variant otherwise. There are three variants for the User Info field, which are HE variant User Info field, EHT variant User Info field, and Special User Info field.

### Embodiment 1

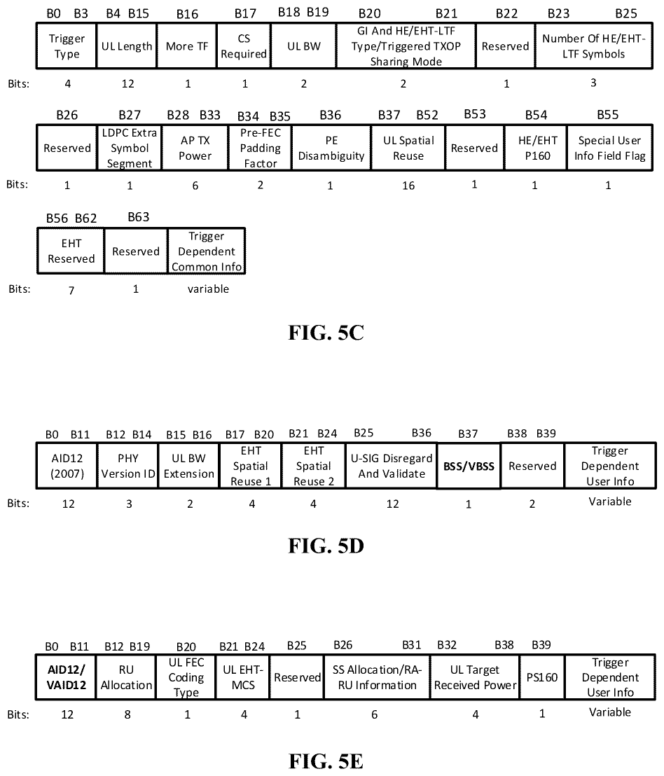

The EHT variant Common Info field format according to the first embodiment is illustrated in FIG. 5A. The EHT variant Common Info field comprises a HE/EHT P160 subfield, a Special User Info Field Flag subfield and a BSS/VBSS subfield. The HE/EHT P160 subfield is set to 0 to indicate that the solicited TB PPDU in the primary 160 MHz is an EHT TB PPDU and set to 1 to indicate that the solicited TB PPDU in the primary 160 MHz is an HE TB PPDU. The Special User Info Field Flag subfield is always set to 0, indicating that a Special User Info field is located immediately after the EHT variant Common Info field. A MAPC capable AP sets the BSS/VBSS subfield to indicate whether the solicited EHT TB PPDUs are transmitted in a BSS or VBSS. A MAPC incapable AP always set the BSS/VBSS subfield to indicate that the solicited EHT TB PPDUs are transmitted in a BSS.

In one embodiment, the BSS/VBSS subfield positions at any of B56 to B62 of the EHT variant Common Info field, as illustrated in FIG. 5A. In this case, the BSS/VBSS subfield is set to 0 to indicate that the solicited EHT TB PPDUs are transmitted in a VBSS and set to 1 to indicate that the solicited EHT TB PPDUs are transmitted in a BSS. As a result, when a MAPC incapable STA determines the value of the BSS/VBSS subfield of a received Trigger frame is not a desired value (i.e., 1), it may stop parsing the User Info List field and thus reduce power consumption. Optionally, in another embodiment, the BSS/VBSS subfield positions at any of B56 to B62 of the EHT variant Common Info field, the BSS/VBSS subfield is set to 1 to indicate that the solicited EHT TB PPDUs are transmitted in a VBSS and set to 0 to indicate that the solicited EHT TB PPDUs are transmitted in a BSS. As a result, when a MAPC incapable STA determines the value of the BSS/VBSS subfield of a received Trigger frame is not a desired value (i.e., 0), it may stop parsing the User Info List field and thus reduce power consumption. In another embodiment, the BSS/VBSS subfield positions at any of B22, B26, B53 and B63 of the EHT variant Common Info field. In this case, the BSS/VBSS subfield is set to 1 to indicate that the solicited EHT TB PPDUs are transmitted in a VBSS and set to 0 to indicate that the solicited EHT TB PPDUs are transmitted in a BSS. As a result, when a MAPC incapable STA determines the value of the BSS/VBSS subfield of a received Trigger frame is not a desired value (i.e., 0), it may stop parsing the User Info List field and thus reduce power consumption. Further, in another embodiment, the BSS/VBSS subfield positions at any of B22, B26, B53 and B63 of the EHT variant Common Info field. In this case, the BSS/VBSS subfield is set to 0 to indicate that the solicited EHT TB PPDUs are transmitted in a VBSS and set to 1 to indicate that the solicited EHT TB PPDUs are transmitted in a BSS. As a result, when a MAPC incapable STA determines the value of the BSS/VBSS subfield of a received Trigger frame is not a desired value (i.e., 1), it may stop parsing the User Info List field and thus reduce power consumption. The Special User Info field format according to the first embodiment is illustrated in FIG. 5B. The PHY Version ID subfield indicates the PHY version. The PHY Version ID subfield is set to 0 for EHT. The UL BW Extension subfield, together with the UL BW subfield in the Common Info field, indicates the bandwidth in the U-SIG field of the solicited EHT TB PPDUs. The U-SIG Disregard and Validate subfield carries the value to be included in the Disregard and Validate subfields of the U-SIG field of the solicited EHT TB PPDUs.

According to the first embodiment, B25 to B30, B31 and B32 to B36 of the U-SIG Disregard and Validate subfield of the Special User Info field corresponds to B20 to B25 of the U-SIG-1 field, B2 of the U-SIG-2 field and B11 to B15 of the U-SIG-2 field of EHT TB PPDU, respectively. For simplifying implementation, if one or more bit of the Disregard and Validate subfields of the U-SIG field of EHT TB PPDU is used for a certain signaling purpose, the corresponding bit of the U-SIG Disregard and Validate subfield of the Special User Info field is reserved. For example, as shown in Table 2, if B25 of the U-SIG-1 field of EHT TB PPDU is used as the BSS/VBSS subfield, B30 of the U-SIG Disregard and Validate subfield of the Special User Info field is reserved.

### Embodiment 2

The EHT variant Common Info field format according to the second embodiment is illustrated in FIG. 5C. The HE/EHT P160 subfield is set to 0 to indicate that the solicited TB PPDU in the primary 160 MHz is an EHT TB PPDU and set to 1 to indicate that the solicited TB PPDU in the primary 160 MHz is an HE TB PPDU. The Special User Info Field Flag subfield is always set to 0, indicating that a Special User Info field is located immediately after the EHT variant Common Info field.

The Special User Info field format according to the second embodiment is illustrated in FIG. 5D. The PHY Version ID subfield indicates the PHY version. The PHY Version ID subfield is set to 0 for EHT. The UL BW Extension subfield, together with the UL BW subfield in the Common Info field, indicates the bandwidth in the U-SIG field of the solicited EHT TB PPDUs. The U-SIG Disregard and Validate subfield carries the value to be included in the Disregard and Validate subfields of the U-SIG field of the solicited EHT TB PPDUs. A MAPC capable AP sets the BSS/VBSS subfield to indicate whether the solicited EHT TB PPDUs are transmitted in a BSS or VBSS. A MAPC incapable AP always set the BSS/VBSS subfield to indicate the solicited EHT TB PPDUs are transmitted in a BSS.

In one embodiment, the BSS/VBSS subfield positions at any of B37 to B39 of the Special User Info field, e.g., B37 as illustrated in FIG. 5D. In this case, the BSS/VBSS subfield is set to 1 to indicate that the solicited EHT TB PPDUs are transmitted in a VBSS and set to 0 to indicate that the solicited EHT TB PPDUs are transmitted in a BSS. As a result, when a MAPC incapable STA determines the value of the BSS/VBSS subfield of a received Trigger frame is not a desired value (i.e., 0), it may stop parsing the remaining User Info fields and thus reduce power consumption.

In another embodiment, the BSS/VBSS subfield positions at any of B25 to B36 of the Special User Info field (e.g., B30). In this case, the BSS/VBSS subfield is set to a first value (e.g., 0) to indicate that the solicited EHT TB PPDUs are transmitted in a VBSS and set to a second value (e.g., 1) to indicate that the solicited EHT TB PPDUs are transmitted in a BSS. In another case, the BSS/VBSS subfield is set to a second value (e.g., 1) to indicate that the solicited EHT TB PPDUs are transmitted in a VBSS and set to a first value (e.g., 0) to indicate that the solicited EHT TB PPDUs are transmitted in a BSS. As a result, when a MAPC incapable STA determines the value of the BSS/VBSS subfield of a received Trigger frame is not a desired value (i.e., 1), it may stop parsing the remaining User Info fields and thus reduce power consumption. According to the second embodiment, B25 to B30, B31 and B32 to B36 of the U-SIG Disregard and Validate subfield of the Special User Info field corresponds to B20 to B25 of the U-SIG-1 field, B2 of the U-SIG-2 field and B11 to B15 of the U-SIG-2 field of EHT TB PPDU, respectively. For simplifying implementation, if one or more bit of the Disregard and Validate subfields of the U-SIG field of EHT TB PPDU is used for a certain signalling purpose, the corresponding bit of the U-SIG Disregard and Validate subfield of the Special User Info field is used for the same signalling purpose. For example, as shown in Table 2, if B25 of the U-SIG-1 field of EHT TB PPDU is used as the BSS/VBSS subfield, B30 of the U-SIG Disregard and Validate subfield of the Special User Info field is used as the BSS/VBSS subfield.

According to the first or second embodiment, how a MAPC capable STA or AP interprets the AID12/VAID12 subfield of each EHT variant User Info field depends on the value of the BSS/VBSS subfield. When the BSS/VBSS subfield is set to indicate the solicited EHT TB PPDUs are transmitted in a BSS, the AID12/VAID12 subfield of each EHT variant User Info field is interpreted as the AID12 subfield. When the BSS/VBSS subfield is set to indicate the solicited EHT TB PPDUs are transmitted in a VBSS, the AID12/VAID12 subfield of each EHT variant User Info field is interpreted as the VAID12 subfield. A MAPC incapable STA or AP always interprets the AID12/VAID12 subfield of each EHT variant User Info field as the AID12 subfield.

According to the first or second embodiment, when the VAID12 subfield of an EHT variant User Info field is set to a value in [1 2006], the EHT Variant User Info field is addressed to a MAPC capable STA associated with the VBSS whose VAID is equal to the value in the VAID12 subfield. When the VAID12 subfield of an EHT Variant User Info field is set to a first value (e.g., 2041), the EHT variant User Info field allocates one or more RUs or MRUs to a MAPC capable STA associated with the VBSS. When the VAID12 subfield of an EHT variant User Info field is set to a second value (e.g., 2042), the EHT variant User Info field allocates one or more RUs or MRUs to a MAPC capable STA unassociated with the VBSS. In another example, When the VAID12 subfield of an EHT Variant User Info field is set to a second value (e.g., 2042), the EHT variant User Info field allocates one or more RUs or MRUs to a MAPC capable STA associated with the VBSS. When the VAID12 subfield of an EHT variant User Info field is set to a first value (e.g., 2041), the EHT variant User Info field allocates one or more RUs or MRUs to a MAPC capable STA unassociated with the VBSS. Notice that an HE STA cannot be associated with any AP candidate set; and a Trigger frame with [B54:B55] in the EHT variant Common Info field set to “10” is mainly used to solicit simultaneous transmissions of HE TB PPDUs and EHT TB PPDUs from HE STAs and EHT STAs. As a result, according to the first or second embodiment, the BSS/VBSS subfield shall be set to indicate the solicited EHT TB PPDUs are transmitted in a BSS if [B54:B55] in the EHT variant Common Info field is equal to “10”. That is to say, simultaneous transmissions of HE TB PPDUs and EHT TB PPDUs are disallowed in a VBSS.

The EHT variant User Info field format according to the first or second embodiment is illustrated in FIG. 5E. A User Info field that is addressed to an EHT STA is either an HE variant or an EHT variant. The User Info field is an HE variant addressed to an EHT STA if the B39 of the User Info field is set to 0 and the B54 of the Common Info field is set to 1 in the Trigger frame; otherwise, it is an EHT variant. If solicited by an HE variant User Info field in a Trigger frame, then the addressed EHT STA responds to the Trigger frame with an HE TB PPDU. If solicited by an EHT variant User Info field in a Trigger frame, then the addressed EHT STA responds to the Trigger frame with an EHT TB PPDU.

According to the first or second embodiment, how a MAPC capable STA or AP interprets the AID12/VAID12 subfield of each EHT variant User Info field depends on the value of the BSS/VBSS subfield. When the BSS/VBSS subfield is set to indicate the solicited EHT TB PPDUs are transmitted in a BSS, the AID12/VAID12 subfield of each EHT variant User Info field is interpreted as the AID12 subfield. When the BSS/VBSS subfield is set to indicate the solicited EHT TB PPDUs are transmitted in a VBSS, the AID12/VAID12 subfield of each EHT variant User Info field is interpreted as the VAID12 subfield. A MAPC incapable STA or AP always interprets the AID12/VAID12 subfield of each EHT variant User Info field as the AID12 subfield. According to the first or second embodiment, when the VAID12 subfield of an EHT variant User Info field is set to a value in [1 2006], the EHT Variant User Info field is addressed to a MAPC capable STA associated with the VBSS whose VAID is equal to the value in the VAID12 subfield. When the VAID12 subfield of an EHT Variant User Info field is set to a first value (e.g., 2041), the EHT variant User Info field allocates one or more RUs or MRUs to a MAPC capable STA associated with the VBSS. When the VAID12 subfield of an EHT variant User Info field is set to a second value (e.g., 2042), the EHT variant User Info field allocates one or more RUs or MRUs to a MAPC capable STA unassociated with the VBSS. In another example, when the VAID12 subfield of an EHT Variant User Info field is set to a second value (e.g., 2042), the EHT variant User Info field allocates one or more RUs or MRUs to a MAPC capable STA associated with the VBSS. When the VAID12 subfield of an EHT variant User Info field is set to a first value (e.g., 2041), the EHT variant User Info field allocates one or more RUs or MRUs to a MAPC capable STA unassociated with the VBSS.

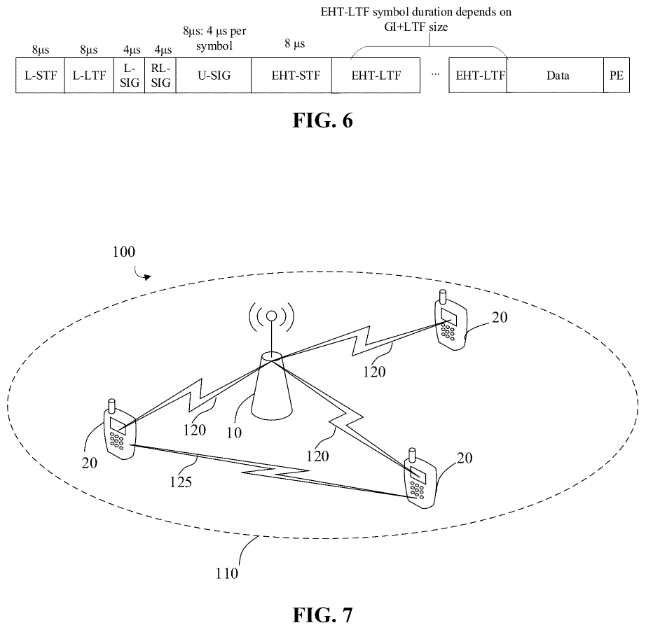

The EHT TB PPDU format as illustrated in FIG. 6 is used for a transmission that is a response to a Trigger frame from an AP. In an EHT TB PPDU, the L-STF, L-LTF, L-SIG, RL-SIG and U-SIG are called pre-EHT modulated fields while the EHT-STF, EHT-LTF, Data field and PE are called EHT modulated fields. The U-SIG field comprises two OFDM symbols, each having a duration of 4 μs. Each EHT-LTF symbol has the same GI duration as each data symbol, which is 0.8 μs, 1.6 μs or 3.2 μs. The EHT-LTF comprises three types: 1×EHT-LTF, 2×EHT-LTF and 4×EHT-LTF. The duration of each 1×EHT-LTF, 2×EHT-LTF or 4×EHT-LTF symbol without GI is 3.2 μs, 6.4 μs or 12.8 μs. Each data symbol without GI is 12.8 μs. The PE duration of an EHT TB PPDU is 0 μs, 4 μs, 8 μs, 12 μs, 16 μs, or 20 μs.

The U-SIG field carries information necessary to interpret EHT TB PPDUs. The U-SIG field is designed to bring forward compatibility to the EHT preamble via the introduction of version independent fields. These are the fields that will be consistent in location and interpretation across multiple IEEE 802.11 PHY versions. The intent of the version independent content is to achieve better coexistence among IEEE 802.11 PHY versions that are defined for 2.4, 5, and 6 GHz spectrum from EHT PHY onwards. In addition, the U-SIG can have some version dependent fields that are fields specific to an IEEE 802.11 PHY version. The U-SIG includes version independent bits followed by version dependent bits. Reserved fields in the U-SIG field are divided into two categories: Validate and Disregard. Validate field values serve to indicate whether to continue reception of an EHT TB PPDU at an EHT STA. If an EHT STA encounters an EHT TB PPDU where at least one field in the U-SIG field that is identified as Validate for the STA is not set to the value specified for the field, the STA shall defer for the duration of the PPDU, report the information from the version independent fields within the RXVECTOR, and terminate the reception of the PPDU. If an EHT STA sees any of the fields identified as Disregard for the STA set to a value that is different from its specified value, it shall ignore these field values and they will have no impact on STA's continued reception of the PPDU (i.e., reception at the STA can continue as usual).

### Embodiment 3

According to the third embodiment, the U-SIG field of an EHT TB PPDU may comprise a BSS/VBSS subfield and a BSS/VBSS Color subfield. An example format of U-SIG field of EHT TB PPDU according to the third embodiment is illustrated in Table 2. In one embodiment, the BSS/VBSS subfield is one of the version independent fields of the U-SIG field. In this case, the BSS/VBSS subfield positions at any of B20 to B25 of the U-SIG-1 field (e.g., B25 as illustrated in Table 1). In another embodiment, the BSS/VBSS subfield is one of the version dependent fields of the U-SIG field. In this case, the BSS/VBSS subfield positions at any of B2 and B11 to B15 of the U-SIG-2 field.

TABLE 2

| Two parts | | | Number | |
|---|---|---|---|---|
| of U-SIG | Bit | Field | of bits | Description |
| U-SIG-1 | B0- | PHY Version | 3 | Differentiate between different PHY clauses. |
| | B2 | Identifier | | Set to 0 for EHT. |
| | | | | Values 1-7 are Validate. |
| | B3- | BW | 3 | Set to 0 for 20 MHz; |
| | B5 | | | Set to 1 for 40 MHz. |
| | | | | Set to 2 for 80 MHz; |
| | | | | Set to 3 for 160 MHz; |
| | | | | Set to 4 for 320 MHz-1; |
| | | | | Set to 5 for 320 MHz-2. |
| | | | | Values 6 and 7 are Validate. |
| | B6 | UL/DL | 1 | Set to 1 to indicate that the PPDU is |
| | | | | addressed to the AP; set to 0 otherwise. |
| | B7- | BSS/VBSS Color | 6 | An identifier of a BSS or VBSS. |
| | B12 | | | |
| | B13- | TXOP | 7 | Set to 127 to indicate no duration |
| | B19 | | | information. |
| | | | | Set to a value less than 127 to indicate |
| | | | | duration information for NAV setting and |
| | | | | protection of the TXOP. |
| | B20- | Disregard | 5 | Set to a value indicated in B25-B29 of the |
| | B24 | | | U-SIG Disregard and Validate subfield in |
| | | | | the Special User Info field in the Trigger |
| | | | | frame and Disregard. |
| | B25 | BSS/VBSS | 1 | Indicates whether the EHT TB PPDU is |
| | | | | transmitted in a BSS or VBSS. |
| U-SIG-2 | B0- | PPDU Type And | 2 | Set to a value of 0 for a TB PPDU. |
| | B1 | Compression Mode | | |
| | B2 | Validate | 1 | Set to a value indicated in B31 of the U-SIG |
| | | | | Disregard and Validate subfield in the |
| | | | | Special User Info field in the Trigger frame |
| | | | | and Validate. |
| | B3- | Spatial Reuse 1 | 4 | Set to the value of the SPATIAL_REUSE(1) |
| | B6 | | | parameter of the TXVECTOR. |
| | B7- | Spatial Reuse 2 | 4 | Set to the value of the SPATIAL_REUSE(2) |
| | B10 | | | parameter of the TXVECTOR. |
| | B11- | Disregard | 5 | Set to a value indicated in B32-B36 of the |
| | B15 | | | U-SIG Disregard and Validate subfield in |
| | | | | the Special User Info field in the Trigger |
| | | | | frame and Disregard. |
| | B16- | CRC | 4 | CRC for bits 0-41 of the U-SIG field. Bits |
| | B19 | | | 0-41 of the U-SIG field correspond to bits |
| | | | | 0-25 of U-SIG-1 followed by bits 0-15 of |
| | | | | U-SIG-2. |
| | B20- | Tail | 6 | Used to terminate the trellis of the |
| | B25 | | | convolutional decoder. Set to 0. |

When a MAPC capable STA transmits an EHT TB PPDU in response to a Trigger frame, the value of the BSS/VBSS subfield of the U-SIG field is copied from the value of the BSS/VBSS subfield of the Trigger frame. Alternatively, the BSS/VBSS subfield of the U-SIG field is set to the value of a BSS/VBSS subfield of the EHT MU PPDU if the Trigger frame is received in an EHT MU PPDU. When a MAPC capable STA transmits an EHT TB PPDU in response to a Trigger frame, if the Trigger frame is received in an EHT MU PPDU, the BSS/VBSS Color subfield of the U-SIG field is set to the value of the BSS/VBSS Color subfield of the EHT MU PPDU. If the Trigger frame is received in a non-EHT PPDU, the BSS/VBSS Color subfield of the U-SIG field is set to the value of an active VBSS color, which is the most recently received VBSS color value of its associated AP candidate set from any AP in its associated AP candidate set.

### Embodiment 4

In the fourth embodiment, it is assumed that VBSS colors are in a same value space with BSS colors. In this case, the value range of a VBSS color does not overlap with the value range of a BSS color. According to the fourth embodiment, the U-SIG field of an EHT TB PPDU may comprise a BSS/VBSS Color subfield. An example format of U-SIG field of EHT TB PPDU according to the fourth embodiment is illustrated in Table 3.

TABLE 3

| Two parts | | | Number | |
|---|---|---|---|---|
| of U-SIG | Bit | Field | of bits | Description |
| U-SIG-1 | B0- | PHY Version | 3 | Differentiate between different PHY clauses. |
| | B2 | Identifier | | Set to 0 for EHT. |
| | | | | Values 1-7 are Validate. |
| | B3- | BW | 3 | Set to 0 for 20 MHz; |
| | B5 | | | Set to 1 for 40 MHz. |
| | | | | Set to 2 for 80 MHz; |
| | | | | Set to 3 for 160 MHz; |
| | | | | Set to 4 for 320 MHz-1; |
| | | | | Set to 5 for 320 MHz-2. |
| | | | | Values 6 and 7 are Validate. |
| | B6 | UL/DL | 1 | Set to 1 to indicate that the PPDU is |
| | | | | addressed to the AP. |
| | B7- | BSS/VBSS | 6 | An identifier of a BSS or VBSS. |
| | B12 | Color | | |
| | B13- | TXOP | 7 | Set to 127 to indicate no duration |
| | B19 | | | information. |
| | | | | Set to a value less than 127 to indicate |
| | | | | duration information for NAV setting and |
| | | | | protection of the TXOP. |
| | B20- | Disregard | 6 | Set to a value indicated in B25-B30 of the U- |
| | B24 | | | SIG Disregard and Validate subfield in the |
| | | | | Special User Info field in the Trigger frame |
| | | | | and Disregard. |
| U-SIG-2 | B0- | PPDU Type And | 2 | Set to a value of 0 for a TB PPDU. |
| | B1 | Compression | | |
| | | Mode | | |
| | B2 | Validate | 1 | Set to a value indicated in B31 of the U-SIG |
| | | | | Disregard and Validate subfield in the Special |
| | | | | User Info field in the Trigger frame and |
| | | | | Validate. |
| | B3- | Spatial Reuse 1 | 4 | Set to the value of the SPATIAL_REUSE(1) |
| | B6 | | | parameter of the TXVECTOR. |
| | B7- | Spatial Reuse 2 | 4 | Set to the value of the SPATIAL_REUSE(2) |
| | B10 | | | parameter of the TXVECTOR. |
| | B11- | Disregard | 5 | Set to a value indicated in B32-B36 of the U- |
| | B15 | | | SIG Disregard and Validate subfield in the |
| | | | | Special User Info field in the Trigger frame |
| | | | | and Disregard. |
| | B16- | CRC | 4 | CRC for bits 0-41 of the U-SIG field. Bits 0- |
| | B19 | | | 41 of the U-SIG field correspond to bits 0-25 |
| | | | | of U-SIG-1 followed by bits 0-15 of U-SIG- |
| | | | | 2. |
| | B20- | Tail | 6 | Used to terminate the trellis of the |
| | B25 | | | convolutional decoder. Set to 0. |

When a MAPC capable STA transmits an EHT TB PPDU in response to a Trigger frame, if the Trigger frame is received in an EHT MU PPDU, the BSS/VBSS Color subfield of the U-SIG field is set to the value of the BSS/VBSS Color subfield of the EHT MU PPDU. If the Trigger frame is received in a non-EHT PPDU, the BSS/VBSS Color subfield of the U-SIG field is set to the value of an active VBSS color, which is the most recently received VBSS color value of its associated AP candidate set from any AP in its associated AP candidate set.

FIG. 7 illustrates an example of a wireless communications system according to an embodiment of the present disclosure. The wireless communications system may be an example of a WLAN 100 (also known as a Wi-Fi network) (such as next generation, next big thing (NBT), ultra-high throughput (UHT) or EHT Wi-Fi network) configured in accordance with various aspects of the present disclosure. As described herein, the terms next generation, NBT, UHT, and EHT may be considered synonymous and may each correspond to a Wi-Fi network supporting a high volume of space-time-streams. The WLAN 100 may include an AP 10 and multiple associated STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 may represent a basic service set (BSS) or an extended service set (ESS). The various STAs 20 in the network can communicate with one another through the AP 10. Also illustrated is a coverage area 110 of the AP 10, which may represent a basic service area (BSA) of the WLAN 100. An extended network station (not shown) associated with the WLAN 100 may be connected to a wired or wireless distribution system that may allow multiple APs 10 to be connected in an ESS or a VBSS.

In some embodiments, a STA 20 may be located in the intersection of more than one coverage area 110 and may associate with more than one AP 10. A single AP 10 and an associated set of STAs 20 may be referred to as a BSS. An ESS or a VBSS is a set of connected BSSs. A distribution system (not shown) may be used to connect APs 10 in an ESS or a VBSS. In some cases, the coverage area 110 of an AP 10 may be divided into sectors (also not shown). The WLAN 100 may include APs 10 of different types (such as a metropolitan area, home network, etc.), with varying and overlapping coverage areas 110. Two STAs 20 also may communicate directly via a direct wireless link 125 regardless of whether both STAs 20 are in the same coverage area 110. Examples of direct wireless links 120 may include Wi-Fi direct connections, Wi-Fi tunneled direct link setup (TDLS) links, and other group connections. STAs 20 and APs 10 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.11ay, etc. In some other implementations, peer-to-peer connections or ad hoc networks may be implemented within the WLAN 100.

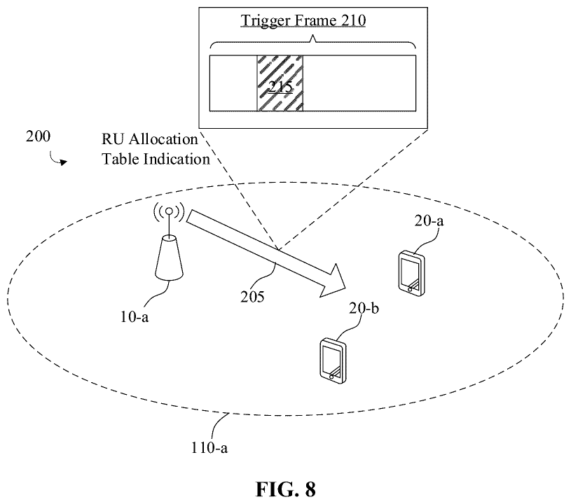

FIG. 8 illustrates an example of a wireless communications system according to another embodiment of the present disclosure. The wireless communications system 200 may be an example of a next generation or EHT Wi-Fi system and may include an AP 10-a and STAs 20-a and 20-b, and a coverage area 110-a, which may be examples of components described with respect to FIG. 8. The AP 10-a may transmit a trigger frame 210 including an RU allocation table indication 215 on the downlink 205 to the STAs 20.

In some implementations, a wireless communications system 200 may be a next generation Wi-Fi system (such as, an EHT system). In some implementations, wireless communications system 200 may also support multiple communications systems. For instance, wireless communications system 200 may support EHT communications and HE communications. In some implementations, the STA 20-a and the STA 20-b may be different types of STAs. For example, the STA 20-a may be an example of an EHT STA, while the STA 20-b may be an example of an HE STA. The STA 20-b may be referred to as a legacy STA.

In some instances, EHT communications may support a larger bandwidth than legacy communications. For instance, EHT communications may occur over an available bandwidth of 320 MHz, whereas legacy communications may occur over an available bandwidth of 160 MHz. Additionally, EHT communications may support higher modulations than legacy communications. For instance, EHT communications may support 4K quadrature amplitude modulation (QAM), whereas legacy communications may support 1024 QAM. EHT communications may support a larger number of spatial streams than legacy systems. In one non-limiting illustrative example, EHT communications may support 16 spatial streams, whereas legacy communications may support 8 spatial streams. In some cases, EHT communications may occur a 2.4 GHz channel, a 5 GHz channel, or a 6 GHz channel in unlicensed spectrum.

In some implementations, AP 10-a may transmit a trigger frame 210 to one or more STAs 20 (such as, STA 20-a and STA 20-b). In some implementations, the trigger frame may solicit an uplink transmission from the STAs 20. However, the trigger frame 210 may be received by an EHT STA 20-a and HE STA 20-b. The trigger frame 210 may be configured to solicit an uplink transmission from only HE STAs 20-b. In some implementations, trigger frame 210 may be configured to solicit an uplink transmission from EHT STAs 20-a. In some other implementations, the trigger frame 210 may be configured to solicit an uplink transmission from one or more EHT STAs 20-a and one or more HE STAs 20-b.

FIG. 9 illustrates an example of a wireless communications system according to another embodiment of the present disclosure. The wireless communications system 300 may be an example of a post-EHT Wi-Fi system and may include an AP 10-b. AP 10-b may be an example of a post-EHT AP 10. The wireless communications system 300 may include HE STA 20-c, EHT STA 20-d, and post-EHT STA 20-e, and a coverage area 110-b, which may be examples of components described with respect to FIG. 7 and FIG. 8. The AP 10-b may transmit a trigger frame 310 including an RU allocation table indication 315 on the downlink 305 to the STAs 20. In some implementations, STAs 20 may be referred to as clients.

In some implementations, an EHT AP 10 may serve both HE STAs 20 and EHT STAs 20. The EHT AP 10 may send a trigger frame that may trigger a response from HE STAs 20 only, from EHT STAs 20 only, or from both HE STAs 20 and EHT STAs 20. STAs 20 that are scheduled in the trigger frame may respond with TB PPDUs. In some implementations, an EHT AP 10 may trigger HE STAs 20 by sending an HE trigger frame format. In some implementations, an EHT AP 10 may trigger EHT STAs 20 by sending an HE trigger frame format or an HE trigger frame format including some field or bit allocation adjustments. In some implementations, an EHT AP 10 may trigger EHT STAs 20 and HE STAs 20 by sending an HE trigger frame format including some field or bit allocation adjustments.

The trigger frame 310 may solicit a response from one or more EHT STAs 20 or one or more HE STAs 20, or both. In some implementations, STAs 20 may not transmit unsolicited uplink transmissions in response to trigger frame 310. In some implementations, trigger frame 310 may solicit an uplink OFDMA transmission or an OFDMA with MU-MIMO transmission.

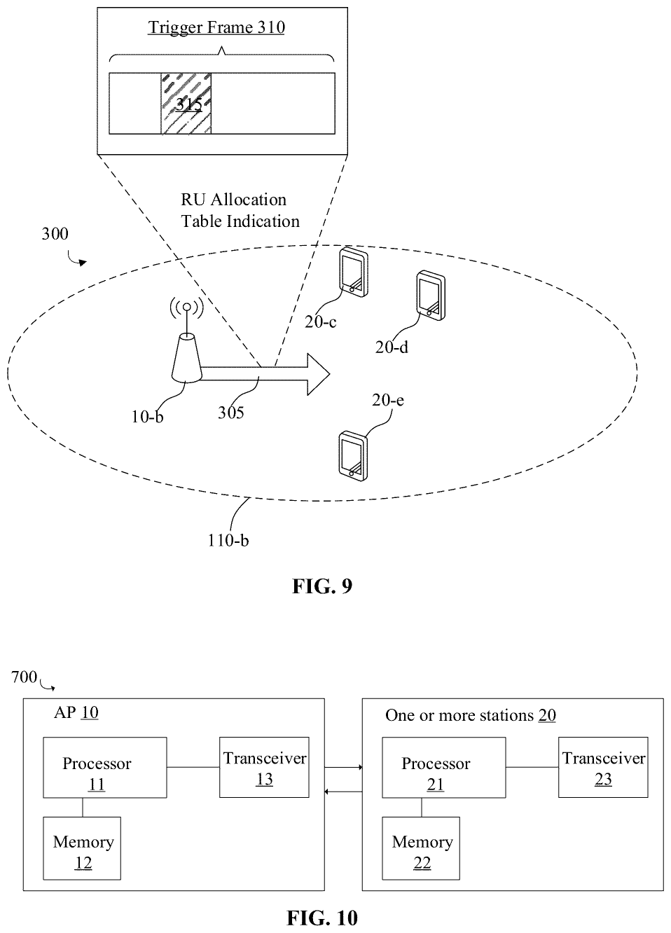

FIG. 10 illustrates one or more STAs 20 and an AP 10 of communication in a wireless communications system 700 according to an embodiment of the present disclosure. FIG. 10 illustrates that, the wireless communications system 700 includes an AP 10 and one or more STAs 20. The AP 10 may include a memory 12, a transceiver 13, and a processor 11 coupled to the memory 12, the transceiver 13. The one or more STAs 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to transmit, to one or more stations (STAs) 20 by the AP 10 involved in a multi-AP coordinated uplink (UL) transmission, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS. This can solve issues in the prior art, efficiently implement multi-AP uplink (UL) coordination in a multi-AP system, achieve extremely high throughput, provide good communication performance, and/or provide high reliability.

In some embodiments, the transceiver 13 is configured to receive, from one or more stations (STAs) 20, an extremely high throughput (EHT) trigger based (TB) physical layer protocol data unit (PPDU) as a response to the trigger frame, wherein the EHT TB PPDU comprises a U-SIG field, and the U-SIG field comprises a BSS/VBSS color subfield. This can solve issues in the prior art, efficiently implement multi-AP uplink (UL) coordination in a multi-AP system, achieve extremely high throughput, provide good communication performance, and/or provide high reliability.

In some embodiments, the transceiver 23 is configured to receive, from the access point (AP) 10 involved in a multi-AP coordinated uplink (UL) transmission, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS. This can solve issues in the prior art, efficiently implement multi-AP uplink (UL) coordination in a multi-AP system, achieve extremely high throughput, provide good communication performance, and/or provide high reliability.

In some embodiments, the transceiver 23 is configured to transmit, to the access point (AP) 10, an extremely high throughput (EHT) trigger based (TB) physical layer protocol data unit (PPDU) as a response to the trigger frame, wherein the EHT TB PPDU comprises a U-SIG field, and the U-SIG field comprises a BSS/VBSS color subfield. This can solve issues in the prior art, efficiently implement multi-AP uplink (UL) coordination in a multi-AP system, achieve extremely high throughput, provide good communication performance, and/or provide high reliability.

In some embodiments, an access point (AP) 10 includes a transmitting unit (such as, the reference number 13 of FIG. 10), wherein the AP 10 is involved in a multi-AP coordinated uplink (UL) transmission, and the transmitting unit is configured to transmit, to one or more stations (STAs) 20, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS.

In some embodiments, a station (STA) 20 includes a receiving unit (such as, the reference number 23 of FIG. 10) configured to receive, from an access point (AP) 10 involved in a multi-AP coordinated uplink (UL) transmission, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS.

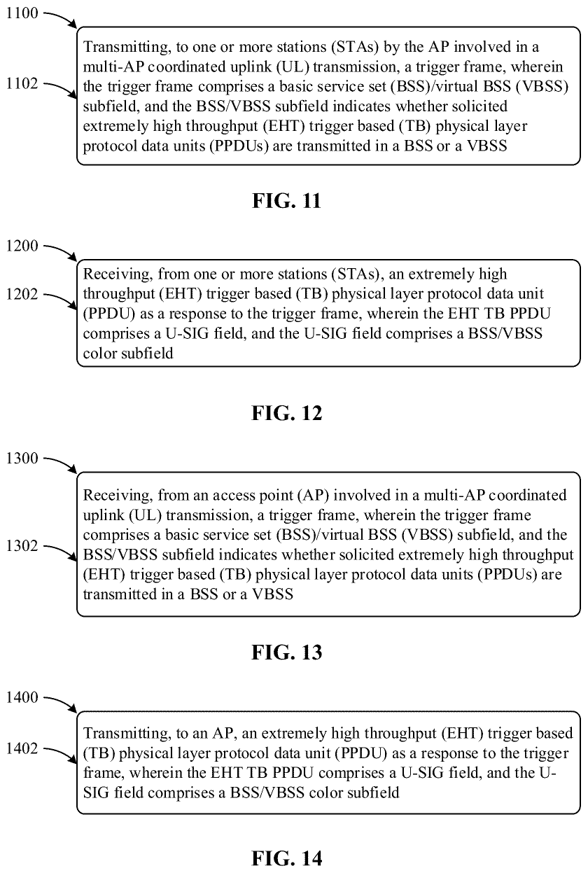

FIG. 11 illustrates a wireless communication method 1100 performed by an AP according to an embodiment of the present disclosure. In some embodiments, the method 1100 includes: a block 1102, transmitting, to one or more stations (STAs) by the AP involved in a multi-AP coordinated uplink (UL) transmission, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS. This can solve issues in the prior art, efficiently implement multi-AP uplink (UL) coordination in a multi-AP system, achieve extremely high throughput, provide good communication performance, and/or provide high reliability.

FIG. 12 illustrates a wireless communication method 1200 performed by an AP according to an embodiment of the present disclosure. In some embodiments, the method 1200 includes: a block 1202, receiving, from one or more stations (STAs), an extremely high throughput (EHT) trigger based (TB) physical layer protocol data unit (PPDU) as a response to the trigger frame, wherein the EHT TB PPDU comprises a U-SIG field, and the U-SIG field comprises a BSS/VBSS color subfield. This can solve issues in the prior art, efficiently implement multi-AP uplink (UL) coordination in a multi-AP system, achieve extremely high throughput, provide good communication performance, and/or provide high reliability.

FIG. 13 illustrates a wireless communication method 1300 performed by a STA according to an embodiment of the present disclosure. In some embodiments, the method 1300 includes: a block 1302, receiving, from an access point (AP) involved in a multi-AP coordinated uplink (UL) transmission, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS. This can solve issues in the prior art, efficiently implement multi-AP uplink (UL) coordination in a multi-AP system, achieve extremely high throughput, provide good communication performance, and/or provide high reliability.

FIG. 14 illustrates a wireless communication method 1400 performed by a STA according to an embodiment of the present disclosure. In some embodiments, the method 1400 includes: a block 1402, transmitting, to an AP, an extremely high throughput (EHT) trigger based (TB) physical layer protocol data unit (PPDU) as a response to the trigger frame, wherein the EHT TB PPDU comprises a U-SIG field, and the U-SIG field comprises a BSS/VBSS color subfield. This can solve issues in the prior art, efficiently implement multi-AP uplink (UL) coordination in a multi-AP system, achieve extremely high throughput, provide good communication performance, and/or provide high reliability.

In some embodiments, a transmitter address (TA) field of the trigger frame is set to a BSS identifier (BSSID) of the AP if the AP is an anchor AP of each of the one or more STAs. In some embodiments, the TA field of the trigger frame is set to a virtual BSSID (VBSSID) of an AP candidate set with which the one or more STAs are associated if the AP is not an anchor AP of at least one of the one or more STAs. In some embodiments, the trigger frame is the same as another trigger frame transmitted by another AP involved in the multi-AP coordinated UL transmission. In some embodiments, the BSS/VBSS subfield positions at any of B56 to B62 of an EHT variant common information field of the trigger frame. In some embodiments, the BSS/VBSS subfield is set to 0 to indicate that the solicited EHT TB PPDUs are transmitted in the VBSS and set to 1 to indicate that the solicited EHT TB PPDUs are transmitted in the BSS. In some embodiments, the BSS/VBSS subfield positions at any of B22, B26, B53, and B63 of an EHT variant common information field of the trigger frame. In some embodiments, the BSS/VBSS subfield is set to 1 to indicate that the solicited EHT TB PPDUs are transmitted in the VBSS and set to 0 to indicate that the solicited EHT TB PPDUs are transmitted in the BSS.

In some embodiments, the BSS/VBSS subfield positions at any of B37 to B39 of a special user information field of the trigger frame. In some embodiments, the BSS/VBSS subfield is set to 1 to indicate that the solicited EHT TB PPDUs are transmitted in the VBSS and set to 0 to indicate that the solicited EHT TB PPDUs are transmitted in the BSS. In some embodiments, the BSS/VBSS subfield positions at any of B25 to B36 of a special user information field of the trigger frame. In some embodiments, the BSS/VBSS subfield is set to 0 to indicate that the solicited EHT TB PPDUs are transmitted in the VBSS and set to 1 to indicate that the solicited EHT TB PPDUs are transmitted in the BSS. In some embodiments, if one or more bits of disregard and validate subfields of a universal signal (U-SIG) field of the EHT TB PPDU is used for a certain signaling purpose, a corresponding bit of a U-SIG disregard and validate subfield of a special user information field of the trigger frame is reserved. In some embodiments, if B25 of a U-SIG-1 field of the EHT TB PPDU is used as the BSS/VBSS subfield, B30 of the U-SIG disregard and validate subfield of the special user information field of the trigger frame is reserved.

In some embodiments, if one or more bits of disregard and validate subfields of a universal signal (U-SIG) field of the EHT TB PPDU is used for a certain signaling purpose, a corresponding bit of a U-SIG disregard and validate subfield of a special user information field of the trigger frame is used for the same signaling purpose. In some embodiments, if B25 of a U-SIG-1 field of the EHT TB PPDU is used as the BSS/VBSS subfield, B30 of the U-SIG disregard and validate subfield of the special user information field of the trigger frame is used as the BSS/VBSS subfield. In some embodiments, each EHT variant user information field of the trigger frame comprises an association identifier (AID)12/virtual AID (VAID)12 subfield. In some embodiments, when the BSS/VBSS subfield indicates the solicited EHT TB PPDUs are transmitted in the VBSS, the AID12/VAID12 subfield is interpreted as a VAID12 subfield. In some embodiments, when the BSS/VBSS subfield indicates the solicited EHT TB PPDUs are transmitted in the BSS, the AID12/VAID12 subfield is interpreted as an AID12 subfield.

In some embodiments, when the VAID12 subfield of the EHT variant user information field is set to a value in [1 2006], the EHT variant user information field is addressed to an STA associated with the VBSS whose VAID is equal to a value in the VAID12 subfield. In some embodiments, when the VAID12 subfield of the EHT variant user information field is set to a first value, the EHT variant user information field allocates one or more resource units (RUs) or multiple resource units (MRUs) to an STA associated with the VBSS. In some embodiments, the first value is equal to 2041. In some embodiments, when the VAID12 subfield of the EHT variant user information field is set to a second value, the EHT variant user information field allocates one or more RUs or MRUs to an STA associated with the VBSS. In some embodiments, the second value is equal to 2042. In another embodiments, when the VAID12 subfield of the EHT variant user information field is set to a second value, the EHT variant user information field allocates one or more resource units (RUs) or multiple resource units (MRUs) to an STA associated with the VBSS. In some embodiments, the second value is equal to 2042. In some embodiments, when the VAID12 subfield of the EHT variant user information field is set to a first value, the EHT variant user information field allocates one or more RUs or MRUs to an STA associated with the VBSS. In some embodiments, the first value is equal to 2041. In some embodiments, the BSS/VBSS subfield is set to indicate that the solicited EHT TB PPDUs are transmitted in a BSS if [B54: B55] in an EHT variant common information field of the trigger frame is equal to 10.

In some embodiments, in a multi-AP coordinated UL transmission, when the EHT TB PPDUs solicited by the trigger frame which is carried in an EHT MU PPDU, together with the EHT TB PPDUs solicited by any of other trigger frames, are transmitted at a same RU or MRU that occupies all non-punctured 20 MHz channels within a coordinated transmission bandwidth or a frequency portion of the coordinated transmission bandwidth, a BSS/VBSS subfield of the EHT MU PPDU is set to indicate that the EHT MU PPDU is transmitted in a VBSS and/or a BSS/VBSS color subfield of the EHT MU PPDU is set to indicate a VBSS color of the VBSS.

In some embodiments, when the EHT TB PPDUs solicited by the trigger frame which is carried in EHT MU PPDU are transmitted in different frequency portions of a coordinated transmission bandwidth from the EHT TB PPDUs solicited by any of other trigger frames and the AP is an anchor AP of all STAs intended by the trigger frame, a BSS/VBSS subfield of the EHT MU PPDU is set to indicate that the EHT MU PPDU is transmitted in a BSS and/or the BSS/VBSS color subfield of the EHT MU PPDU is set to indicate the BSS color of the BSS.

In some embodiments, when the EHT TB PPDUs solicited by the trigger frame which is carried in an EHT MU PPDU are transmitted in different frequency portions of a coordinated transmission bandwidth from the EHT TB PPDUs solicited by any of other trigger frames and the AP is not an anchor AP of at least one of STAs intended by the trigger frame, the BSS/VBSS subfield of the EHT MU PPDU is set to indicate that the EHT MU PPDU is transmitted in a VBSS and/or the BSS/VBSS color subfield of the EHT MU PPDU is set to indicate a VBSS color of the VBSS.

In some embodiments, the wireless communication method further comprises the AP receiving, from the one or more STAs, the EHT TB PPDU as a response to the trigger frame, wherein the EHT TB PPDU comprises a U-SIG field, and the U-SIG field comprises a BSS/VBSS color subfield. In some embodiments, the EHT TB PPDU comprises a first BSS/VBSS subfield in the U-SIG field. In some embodiments, a value of the first BSS/VBSS subfield of the U-SIG field is copied from a value of the BSS/VBSS subfield of the trigger frame. In some embodiments, the first BSS/VBSS subfield of the U-SIG field is set to a value of a BSS/VBSS subfield of an EHT MU PPDU if the trigger frame is received in the EHT MU PPDU. In some embodiments, the first BSS/VBSS subfield is one of version independent fields of the U-SIG field. In some embodiments, the first BSS/VBSS subfield positions at any of B20 to B25 of U-SIG-1 field. In some embodiments, the first BSS/VBSS subfield is one of version dependent fields of the U-SIG field. In some embodiments, the first BSS/VBSS subfield positions at any of B2 and B11 to B15 of U-SIG-2 field. In some embodiments, if the trigger frame is received in an EHT MU PPDU, the BSS/VBSS color subfield of the U-SIG field is set to a value of a BSS/VBSS color subfield of the EHT MU PPDU. In some embodiments, if the trigger frame is received in a non-EHT PPDU, the BSS/VBSS color subfield of the U-SIG field is set to a value of an active VBSS color, which is the most recently received VBSS color value of an associated AP candidate set from any AP in the associated AP candidate set.

Commercial interests for some embodiments are as follows. 1. Solving issues in the prior art. 2. Efficiently implementing multi-AP downlink (DL) coordination in a multi-AP system. 3. Achieving extremely high throughput. 4. Providing a good communication performance. 5. Providing a high reliability. 6. Some embodiments of the present disclosure are used by chipset vendors, communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in communication specification and/or communication standards such as IEEE specification and/or to standards create an end product. Some embodiments of the present disclosure propose technical mechanisms.

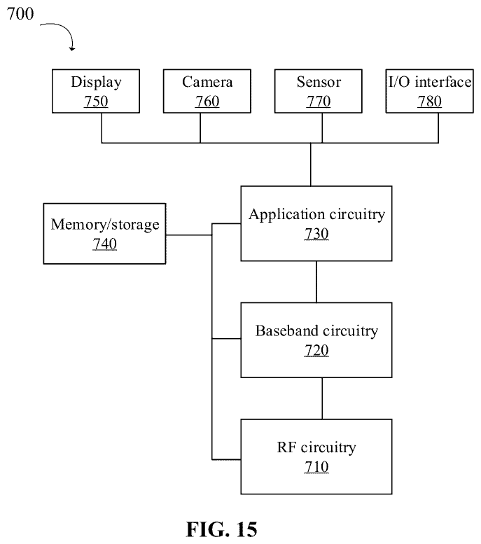

FIG. 15 is a block diagram of an example system 700 for wireless communication according to an embodiment of the present disclosure. Embodiments described herein may be implemented into the system using any suitably configured hardware and/or software. FIG. 15 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the AP or STA may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A station (STA), comprising:
a memory configured to store instructions, a transceiver; and a processor coupled to the memory and the transceiver, wherein the instructions, when executed, cause the STA to:
receive, from an access point (AP) involved in a multi-AP coordinated uplink (UL) transmission, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS.

2. The STA of claim 1, wherein:
a transmitter address (TA) field of the trigger frame is set to a BSS identifier (BSSID) of the AP if the AP is an anchor AP of each of the one or more STAs; or
the TA field of the trigger frame is set to a virtual BSSID (VBSSID) of an AP candidate set with which the one or more STAs are associated if the AP is not an anchor AP of at least one of the one or more STAs.

3. The STA of claim 1, wherein the trigger frame is the same as another trigger frame transmitted by another AP involved in the multi-AP coordinated UL transmission.

4. The STA of claim 1, wherein:
the BSS/VBSS subfield positions at any of B56 to B62 of an EHT variant common information field of the trigger frame; or
the BSS/VBSS subfield positions at any of B22, B26, B53, and B63 of an EHT variant common information field of the trigger frame.

5. The STA of claim 4, wherein the BSS/VBSS subfield is set to 0 to indicate that the solicited EHT TB PPDUs are transmitted in the VBSS and set to 1 to indicate that the solicited EHT TB PPDUs are transmitted in the BSS.

6. The STA of claim 1, wherein:
the BSS/VBSS subfield positions at any of B37 to B39 of a special user information field of the trigger frame; or
the BSS/VBSS subfield positions at any of B25 to B36 of a special user information field of the trigger frame.

7. The STA of claim 6, wherein the BSS/VBSS subfield is set to 1 to indicate that the solicited EHT TB PPDUs are transmitted in the VBSS and set to 0 to indicate that the solicited EHT TB PPDUs are transmitted in the BSS.

8. The STA of claim 1, wherein each EHT variant user information field of the trigger frame comprises an association identifier (AID)12/virtual AID (VAID)12 subfield.

9. The STA of claim 8, wherein:
when the BSS/VBSS subfield indicates the solicited EHT TB PPDUs are transmitted in the VBSS, the AID12/VAID12 subfield is interpreted as a VAID12 subfield; or
when the BSS/VBSS subfield indicates the solicited EHT TB PPDUs are transmitted in the BSS, the AID12/VAID12 subfield is interpreted as an AID12 subfield.

10. The STA of claim 9, wherein when the VAID12 subfield of the EHT variant user information field is set to a value in [1 2006], the EHT variant user information field is addressed to an STA associated with the VBSS whose VAID is equal to a value in the VAID12 subfield.

11. The STA of claim 1, wherein the BSS/VBSS subfield is set to indicate that the solicited EHT TB PPDUs are transmitted in a BSS if [B54: B55] in an EHT variant common information field of the trigger frame is equal to 10.

12. The STA of claim 1, wherein:
in a multi-AP coordinated UL transmission, when the EHT TB PPDUs solicited by the trigger frame which is carried in an EHT MU PPDU, together with EHT TB PPDUs solicited by any of other trigger frames, are transmitted at a same RU or MRU that occupies all non-punctured 20 MHz channels within a coordinated transmission bandwidth or a frequency portion of the coordinated transmission bandwidth, a BSS/VBSS subfield of the EHT MU PPDU is set to indicate that the EHT MU PPDU is transmitted in a VBSS and/or a BSS/VBSS color subfield of the EHT MU PPDU is set to indicate a VBSS color of the VBSS; or
when the EHT TB PPDUs solicited by the trigger frame which is carried in EHT MU PPDU are transmitted in different frequency portions of a coordinated transmission bandwidth from EHT TB PPDUs solicited by any of other trigger frames and the AP is an anchor AP of all STAs intended by the trigger frame, a BSS/VBSS subfield of the EHT MU PPDU is set to indicate that the EHT MU PPDU is transmitted in a BSS and/or a BSS/VBSS color subfield of the EHT MU PPDU is set to indicate a BSS color of the BSS; or
when the EHT TB PPDUs solicited by the trigger frame which is carried in an EHT MU PPDU are transmitted in different frequency portions of a coordinated transmission bandwidth from EHT TB PPDUs solicited by any of other trigger frames and the AP is not an anchor AP of at least one of STAs intended by the trigger frame, the BSS/VBSS subfield of the EHT MU PPDU is set to indicate that the EHT MU PPDU is transmitted in a VBSS and/or a BSS/VBSS color subfield of the EHT MU PPDU is set to indicate a VBSS color of the VBSS.

13. The STA of claim 1, wherein the instructions, when executed, further cause the STA to:
transmit, to the AP, the EHT TB PPDU as a response to the trigger frame, wherein the EHT TB PPDU comprises a U-SIG field, and the U-SIG field comprises a BSS/VBSS color subfield.

14. The STA of claim 13, wherein the EHT TB PPDU comprises a first BSS/VBSS subfield in the U-SIG field.

15. The STA of claim 14, wherein a value of the first BSS/VBSS subfield of the U-SIG field is copied from a value of the BSS/VBSS subfield of the trigger frame.

16. The STA of claim 14, wherein the first BSS/VBSS subfield of the U-SIG field is set to a value of a BSS/VBSS subfield of an EHT MU PPDU if the trigger frame is received in the EHT MU PPDU.

17. The STA of claim 14, wherein:
the first BSS/VBSS subfield is one of version independent fields of the U-SIG field, and the first BSS/VBSS subfield positions at any of B20 to B25 of U-SIG-1 field; or
the first BSS/VBSS subfield is one of version dependent fields of the U-SIG field, and the first BSS/VBSS subfield positions at any of B2 and B11 to B15 of U-SIG-2 field.

18. The STA of claim 13, wherein:
if the trigger frame is received in an EHT MU PPDU, the BSS/VBSS color subfield of the U-SIG field is set to a value of a BSS/VBSS color subfield of the EHT MU PPDU; or
if the trigger frame is received in a non-EHT PPDU, the BSS/VBSS color subfield of the U-SIG field is set to a value of an active VBSS color, which is the most recently received VBSS color value of an associated AP candidate set from any AP in the associated AP candidate set.

19. A wireless communication method by a station (STA), comprising:
receiving, from an access point (AP) involved in a multi-AP coordinated uplink (UL) transmission, a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS.

20. An access point (AP), comprising:
a memory configured to store instructions, a transceiver, and a processor coupled to the memory and the transceiver, wherein the instructions, when executed, cause the AP involved in a multi-AP coordinated uplink (UL) transmission to:
transmit, to one or more stations (STAs), a trigger frame, wherein the trigger frame comprises a basic service set (BSS)/virtual BSS (VBSS) subfield, and the BSS/VBSS subfield indicates whether solicited extremely high throughput (EHT) trigger based (TB) physical layer protocol data units (PPDUs) are transmitted in a BSS or a VBSS.
